(19) United States
(12) Patent Application Publication
(10) Pub. No.: US 2005/0047856 A1
(43) Pub. Date: Mar. 3, 2005

(54) Cable drive system

(76) Inventor: Stephen W. Allswede, Lansing, MI (US)

Correspondence Address: JOHN F. HOFFMAN;BAKER & DANIELS, 111 EAST WAYNE STREET, SUITE 800, FORT WAYNE, IN, 46802, US

(21) Appl. No.: 10/925,626

(22) Filed: Aug. 25, 2004

Related U.S. Application Data
(60) Provisional application No. 60/499,107, filed on Aug. 29, 2003.

(51) Int. Cl. F16D 1/00

(52) U.S. Cl. 403/326

(57) ABSTRACT

A drive system for drivingly coupling two components to one another, for example, a drive shaft and a driven component such as a flexible cable. The end of the drive shaft is formed with a circular bore, and the end of the flexible cable is formed with a square or other polygonal shape. One or more drive clips within the cylindrical bore drivingly engage the inner surface of the circular bore of the drive shaft, and also conform to the external surfaces of the cable end portion to prevent relative rotation between the drive shaft and the flexible cable, such that same are drivingly coupled.

### CROSS REFERENCE TO RELATED APPLICATIONS

This application claims the benefit under Title 35, U.S.C. § 119(e) of U.S. Provisional Patent Application Ser. No. 60/499,107, entitled CABLE DRIVE SYSTEM, filed on Aug. 29, 2003.

### BACKGROUND OF THE INVENTION

1. Field of the Invention

The present invention relates to drive systems for transferring rotary motion from a drive component to a driven component such as, for example, a drive system in which a flexible cable is driven by an electric motor.

2. Description of the Related Art

Generally, drive systems are used to transfer rotary motion or torque between two components, such as from a drive component to a driven component. For example, a source of rotary motion, such as an electric motor, internal combustion engine, or other power source may be used to drive a rotary device. In some drive systems, a flexible cable is used to transfer rotary motion from a source of rotary motion to a driven device.

In one particular drive system application, a flexible cable is used in drive systems for automobile power adjustable seats. A flexible cable connects the drive shaft of an electric motor and the input shaft of a gear box to transfer rotary motion from the motor to the gear box. Advantageously, the flexible cable allows transfer of rotary motion even when the cable is bent, thereby allowing the cable to bend around a corner in order to fit within a tight space. A driven component, such as a screw shaft, for example, is coupled to the gear box for moving the automobile seat.

Typically, the drive shaft of the electric motor is formed with a hole having a square shape or other polygonal shape. The hole is typically formed by drilling a blind pilot hole in the end of the drive shaft, followed by performing a broaching operation along the pilot hole to form the square or other polygonal shape of the hole. The end of the flexible cable is formed with a square or other polygonal shape which is complimentary to the shape of the hole in the drive shaft of the motor, and the flexible cable end is inserted into the hole of the drive shaft of the motor to drivingly couple the drive shaft and flexible cable together.

Problematically, any spacing or gaps between the flexible cable end and the motor drive shaft due to manufacturing tolerances, for example, may lead to the generation of noise and chatter between the cable end and drive shaft during operation of the drive system.

A known drive system of the type disclosed in U.S. Pat. No. 5,823,499 to Ito et al., shown in FIG. 1, is directed toward addressing the foregoing problem. Known drive system 10 includes a metal spacer 12 which is inserted into broached, square hole 14 of drive shaft 16 of an electric motor. Thereafter, the square end 20 of a flexible cable 22 is inserted into hole 14 of drive shaft 16, with spacer 12 helping to align end 20 of cable 22 with hole 14 of drive shaft 16 and taking up any spacing or gaps between end 20 of cable 22 and hole 14 of drive shaft 16 to reduce noise or chatter during operation of the drive system.

Spacer 12 is formed by initially stamping a cross-shaped blank from a sheet of metal stock, the blank including base portion 24 and four spacer arms 26 all initially disposed within the same plane. Thereafter, the four spacer arms 26 are bent parallel to one another about base portion 24 to form the shape of spacer 12 which is shown in FIG. 1. However, due to the cross shape of the stamped blank of spacer 12, stamping same from a sheet of metal stock is not economical because a large amount of the metal stock is wasted.

Another disadvantage of the foregoing drive system is that the broaching operation needed to form the square or other polygonal shape of hole 14 of drive shaft 16 is a relatively difficult manufacturing step which requires tooling that must be periodically sharpened or replaced, and which is prone to breakage. Further, the broaching operation is expensive, and performance of same could disrupt or damage the outer diameter of the drive shaft.

What is needed is a cable drive system which is an improvement over the foregoing.

### SUMMARY OF THE INVENTION

The present invention provides a drive system for drivingly coupling two components to one another, for example, a drive shaft and a driven component such as a flexible cable. The end of the drive shaft is formed with a circular bore, and the end of the flexible cable is formed with a square or other polygonal shape. One or more drive clips within the cylindrical bore drivingly engage the inner surface of the circular bore of the drive shaft, and also conform to the external surfaces of the cable end portion to prevent relative rotation between the drive shaft and the flexible cable, such that same are drivingly coupled.

Advantageously, the driving engagement of the drive clip arms and the circular bore of the drive shaft provides a driving connection between the drive shaft and the cable end portion while eliminating the need of a broaching operation to form a square or other polygonal shaped hole in the end of the drive shaft which conforms to the shape of the cable end portion. In this manner, the difficulty and expense of manufacturing the present drive system is greatly reduced as compared to known drive systems. Additionally, using multiple drive clips of the shape described herein allows the drive clips to be economically formed from metal stock by a stamping operation in which waste of metal stock is greatly reduced.

In one form thereof, the present invention provides a drive system, including a first rotatable component including a circular bore having an inner surface; a second rotatable component having an end portion with at least one external surface, the end portion inserted within the bore; and at least one drive clip disposed between the bore of the first component and the end portion of the second component, each drive clip in driving engagement with the inner surface of the bore and in abutting engagement with said at least one external surface of the end portion, whereby rotary motion is transferred between the first and second components through the at least one drive clip.

In another form thereof, the present invention provides a drive system, including a first rotatable component including a circular bore having an inner surface; a second rotatable component having a polygonal shaped end portion with a plurality of external surfaces, the end portion inserted within the bore; and at least one drive clip disposed between the bore of the first component and the end portion of the second component, each drive clip including a pair of opposed arm portions in abutment with opposing external surfaces of the end portion of the second component, and a pair of opposing edges on each arm portion, the edges in tight frictional driving engagement with the inner surface of the bore, whereby rotary motion is transferred between the first and second components through the at least one drive clip.

In a further form thereof, the present invention provides a drive system, including a first rotatable component having a polygonal shaped hole therein; a second rotatable component having a polygonal shaped end portion conforming in shape to the polygonal hole, the end portion inserted within the polygonal hole; and at least two separate drive clips disposed between the polygonal hole and the end portion of the second component, each drive clip including at least one arm portion in close fitting abutment between respective surfaces of the hole and the end portion, whereby rotary motion is transferred between the first and the second components through the drive clips.

In a still further form thereof, the present invention provides a method of assembling a drive system, including the steps of inserting at least one drive clip having opposing arm portions with edges into a circular bore of a shaft; inserting an end portion of a component into the bore between the drive clip arms; and pressing the edges of the drive clip arms into tight frictional driving engagement with an inner surface of the bore.

### BRIEF DESCRIPTION OF THE DRAWINGS

The above-mentioned and other features and advantages of this invention, and the manner of attaining them, will become more apparent and the invention itself will be better understood by reference to the following description of an embodiment of the invention taken in conjunction with the accompanying drawings, wherein:

FIG. 1 is an exploded view showing components of a known drive system, including a drive shaft of an electric motor, a spacer, and a flexible cable;

FIG. 2 is an exploded view showing components of a drive system according to the present invention, including an electric motor with a drive shaft having a circular bore, as well as a flexible cable and a selection of drive clips;

FIG. 3 is a partial sectional view of the motor and drive shaft of FIG. 2 with a pair of drive clips disposed within the bore of the drive shaft, showing insertion of the end of the flexible cable into the drive shaft bore;

FIG. 4 is a partial sectional view of the motor and drive shaft of FIG. 3, showing the end of the flexible cable inserted into the drive shaft bore to drivingly couple the drive shaft and the flexible cable;

FIG. 5 is a perspective view of a section of metal stock, showing the manner in which a plurality of drive clips are stamped therefrom;

FIG. 6 is a perspective view of a drive clip blank which has been stamped from the metal stock of FIG. 5, showing subsequent bending of the drive clip arms to form the drive clip; and

FIG. 7 is a sectional view taken along line 7-7 of FIG. 4.

Corresponding reference characters indicate corresponding parts throughout the several views. The exemplifications set out herein illustrate preferred embodiments of the invention, and such exemplifications are not to be construed as limiting the scope of the invention any manner.

### DETAILED DESCRIPTION

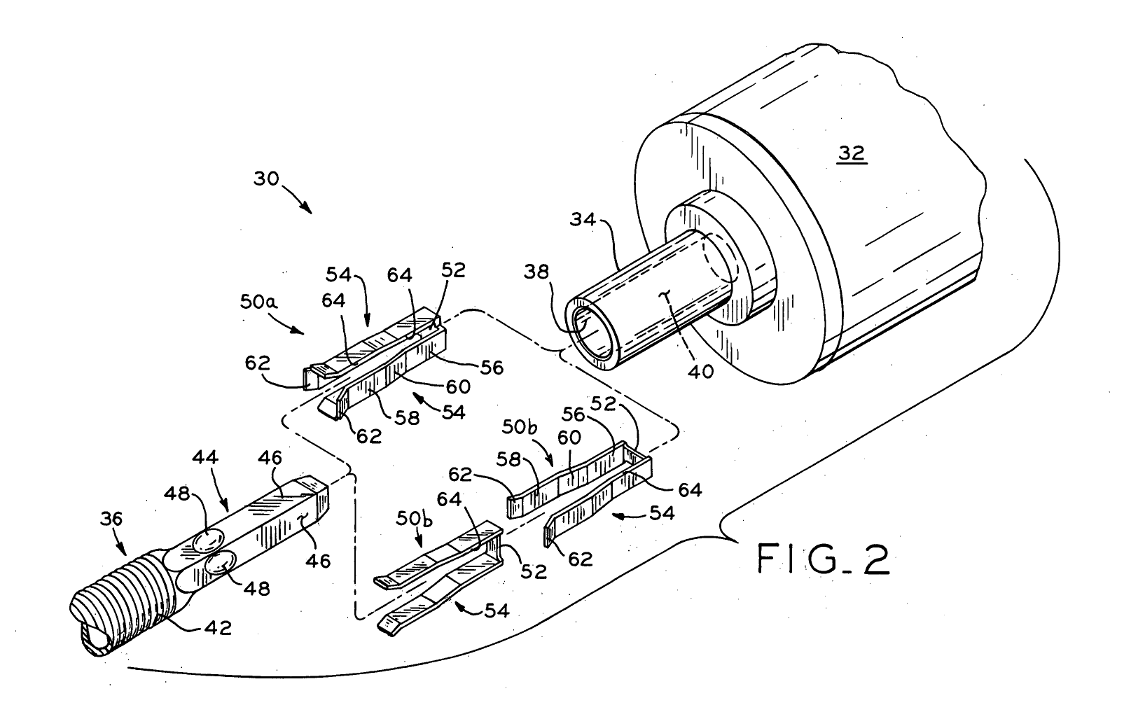

Referring to FIG. 2, the components of drive system 30 according to the present invention are shown. Drive system 30 includes a prime mover or rotary motion source, shown herein as electric motor 32 having rotatable drive shaft 34. Drive shaft 34 is coupled to flexible cable 36 to provide a driving connection therebetween for transmitting rotary power or torque from drive shaft 34 of motor 32 through flexible cable 36 to a gear box or other driven device (not shown).

Although drive system 30 is described herein in the exemplary form of a driving connection between an electric motor and a flexible cable, the present invention is also more generally applicable to other types of drive systems in which rotary motion is transferred from any type of drive component to any type of driven component such as an axle or rigid shaft, for example, or other driving connections including solid links. Additionally, although the present invention is described below with reference to exemplary drive system 30, in which the polygonal end of a flexible cable fits within a circular bore of a motor drive shaft, the present invention is equally applicable in an opposite configuration, in which a motor drive shaft includes a polygonal end portion for fitting within a circular bore in the end of a flexible cable.

Drive shaft 34 includes circular bore 38. Generally, bore 38 may be a blind bore formed in the end of drive shaft 34 by a suitable drilling or boring operation. Bore 38 may include a relatively rough inner surface 40 formed by a drilling operation, for example, without subsequent machining or finishing, or may be finished as desired.

Flexible cable 36 includes flexible section 42 of a desired length, which typically has a circular or tubular shape. End portions 44 of flexible cable 36, only one of which is shown in FIGS. 2-4, have a square shape defined by a plurality of planar external surfaces 46. Alternatively, end portions 44 of flexible cable 36 may have any other polygonal shape, such as triangular, pentagonal, or hexagonal, for example. Additionally, end portions 44 of flexible cable 36 may optionally include a plurality of upstands 48 projecting outwardly from end portions 44. In FIGS. 2-4, upstands 48 are shown as smooth bumps, however, the particular shape of upstands 48 may vary. For example, upstands 48 may be formed as a series of ridges, or as a single portion of enlarged width with respect to the end portion 44 of cable 36. Upstands 48 are optional wherein, even if end portions 44 of cable 36 lack upstands 48, end portions 44 of cable 36 may still engage drive clips 50a or 50b to force same into biting engagement with inner surface 40 of bore 38 in the manner described below.

As discussed below, drive system 30 may include either a single drive clip or a plurality of two or more drive clips. A first, single drive clip 50a is shown in FIG. 2, which includes a base portion 52 and four drive clip arms 54 extending from base portion 52. A second, pair of drive clips 50b each include base portion 52 and two drive clip arms 54 extending from base portion 52. In each of drive clips 50a and 50b, drive clip arms 54 extend generally parallel to one another, and include first sections 56 and second sections 58 connected by transition portion 60. Transition portion 60 is formed as a crank or bend within drive clips arms 54 which offsets second sections 58 outwardly of first sections 56. Drive clip arms 54 terminate in end portions 62 which are bent at an angle outwardly from second sections 58 of drive clip arms 54. Additionally, each drive clip arm 54 includes a pair of opposite edges 64.

Drive clips 50a and 50b are each made from a suitable metal, such as spring steel, aluminum, or sheet metal, for example. Typically, the metal from which drive clips 50a and 50b are formed is harder than the material of drive shaft 34 of motor 32 for reasons discussed below. Typically, drive clips 50a and 50b are formed from a flat piece of metal stock by a stamping operation in which a plurality of drive clip blanks are stamped from a metal sheet by suitable dies, for example, followed by performing subsequent stamping, bending, forming, or crimping operations on the blanks.

Drive clip 50a, as discussed above, is initially stamped as a cross-shaped blank in which base portion 52 and drive clip arms 54 are each disposed in the same plane. In subsequent operations, transition portion 60 and end portions 62 are formed in drive clip arms 54, and drive clip arms 54 are then bent parallel to one another to form the shape of drive clip 50a which is shown in FIG. 2.

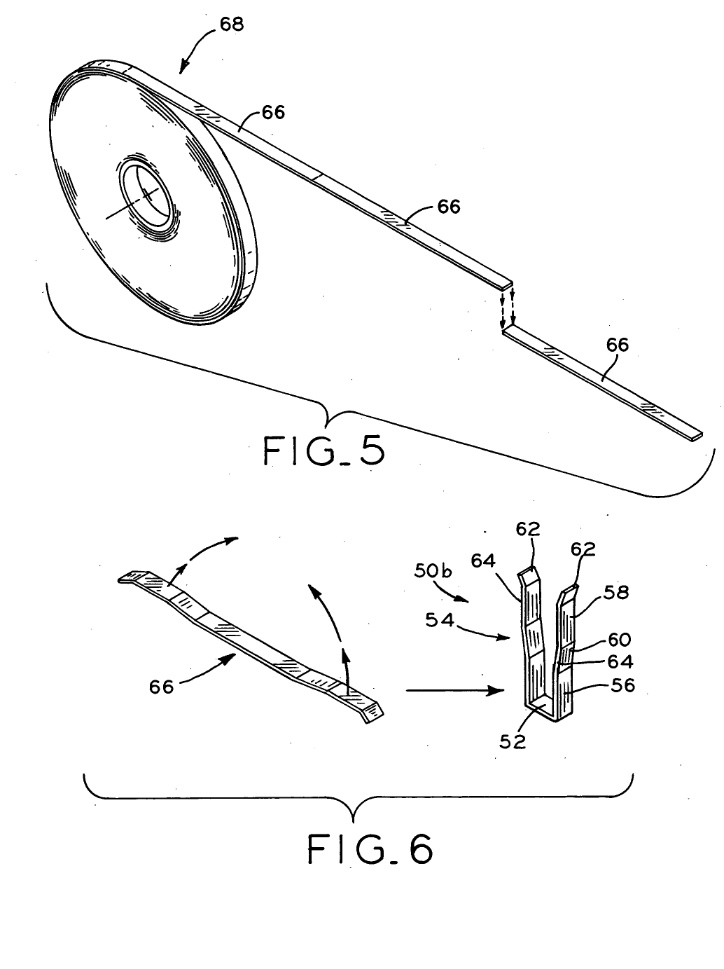

Referring to FIG. 5, drive clips 50b may be formed by stamping drive clip blanks 66 from a length of metal stock. As may be seen in FIG. 5, drive clip blanks 66 each have a width substantially equal to the width of the metal stock. In this manner, stamping drive clip blanks 66 generates little or no waste of metal stock 68. Referring to FIG. 6, in subsequent bending or crimping operations, transition portion 60 and end portions 62 are formed in drive clip arms 54, and same are then bent parallel to one another to form the shape of drive clips 50b which is shown in FIGS. 2 and 6.

Edges 64 of drive clips 50a and 50b may remain unfinished, i.e., edges 64 may include burrs or other irregularities as a result of the stamping operation by which drive clips 50a and 50b are formed from metal stock. Further, at a suitable time during manufacture of drive clips 50a and 50b, drive clips 50a and 50b may be hardened in a suitable manner such as by heat treatment. Drive clips 50a and 50b desirably have a hardness greater than that of drive shaft 34 of motor 32, and drive clips 50a and 50b may have a hardness of at least 10 Rockwell C units greater than the hardness of drive shaft 34 of motor 32.

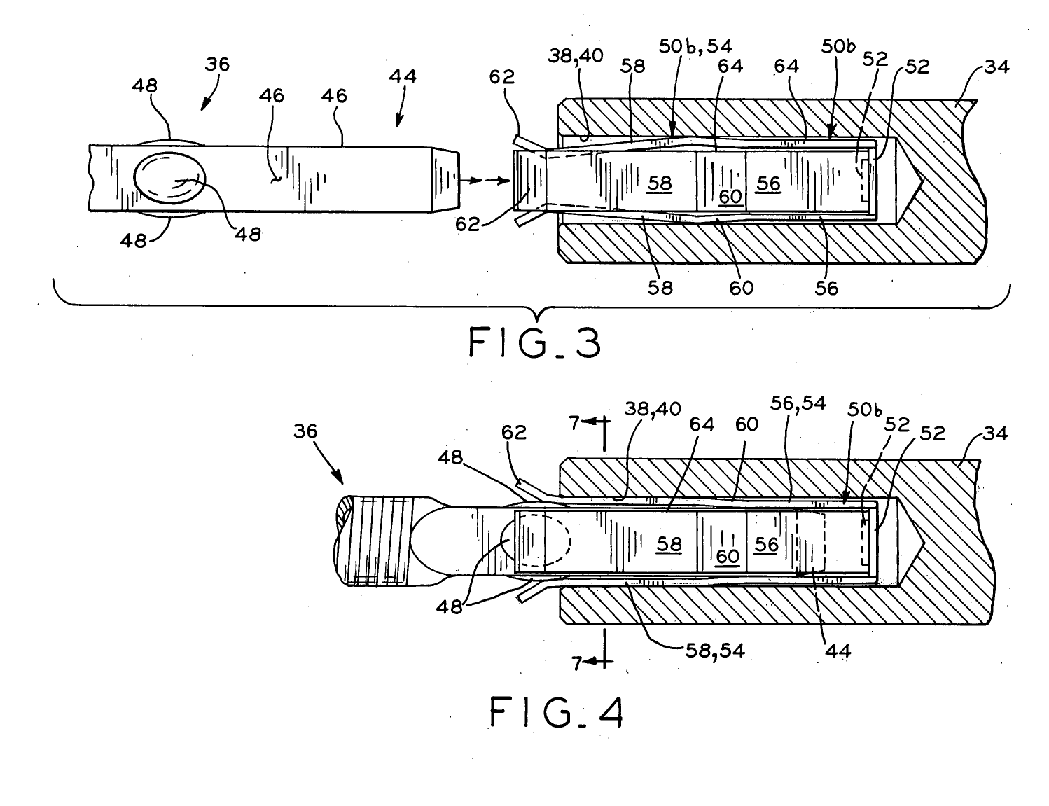

To assemble drive system 30, either a single drive clip 50a or a pair of drive clips 50b may be used, as shown in FIG. 2. In one configuration, a single drive clip 50a is inserted into bore 38 of drive shaft 34 such that base portion 52 of drive clip 50a enters bore 38 first, with end portions 62 of drive clip arms 54 disposed outwardly of bore 38. In another configuration, a pair of drive clips 50b are inserted into bore 38 of drive shaft 34 at a 90° orientation to one another and in a stacked relationship in which base portions 52 of drive clips 50b are stacked atop one another, as shown in FIG. 3, with end portions 62 of drive clip arms 54 disposed outwardly of bore 38. Drive clips 50a or 50b may be typically rather easily inserted into bore 38 of drive shaft 34 without the need for tools.

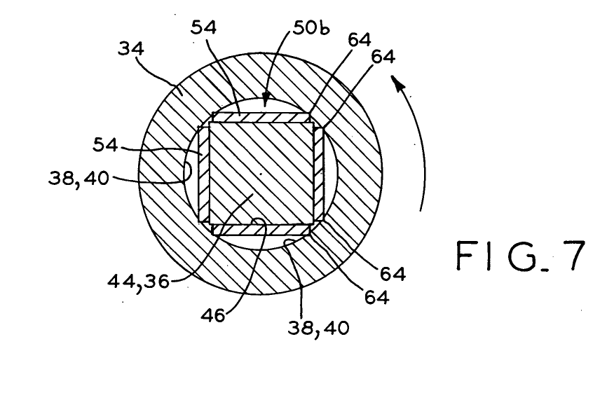

Referring to FIG. 3, for both drive clips 50a and 50b, transition portions 60 of drive clip arms 54 are dimensioned to engage inner surface 40 of bore 38 upon insertion of drive clips 50a, 50b, such that second sections 58 of drive clip arms 54 are bent slightly inwardly. Further, edges 64 of drive clip arms 54 may loosely frictionally engage inner surface 40 of bore 38. As shown in FIG. 7, because bore 38 is circular and drive clip arms 54 of drive clips 50a, 50b have a square profile, drive clip arms 54 do not conform in shape to bore 38. However, as discussed below, upon insertion of end 44 of cable 36 into bore 38, drive clips 50a, 50b drivingly engage bore 38 of drive shaft 34.

Thereafter, end portion 44 of flexible cable 36 is inserted into bore 38, with end portions 62 of drive clip arms 54 guiding the insertion of end portion 44 of cable 36 into bore 38. Upon insertion of end portion 44 of flexible cable 36, upstands 48 of cable 36 engage end portions 62 and second sections 58 of drive clip arms 54, thereby flexing and expanding second sections 58, pressing same into tight engagement with inner surface 40 of bore 38. Also, as shown in FIG. 7, upon insertion of end portion 44 of cable 36, edges 64 of drive clip arms 54 bite into inner surface 40 of bore 38, which biting-in engagement is facilitated by drive clips 50a and 50b being made of a harder material than drive shaft 34. Further, the biting-in engagement of edges 64 of drive clip arms 54 with inner surface 40 of bore 38 may be enhanced if edges 64 of drive clip arms 54 include burrs or other irregularities. End portion 44 of flexible cable 36 is typically inserted into bore 38 a suitable distance until the end thereof is adjacent base portions 52 of drive clips 50a or 50b, for example, as shown in FIG. 4.

As shown in FIG. 7 and described above, the edges 64 of drive clips arms 54 drivingly engage inner surface 40 of bore 38, in which edges 64 frictionally engage and bite into inner surface 40 of bore 38 to prevent relative rotation between drive shaft 34 and drive clips 50a or 50b. In particular, the biting-in engagement of edges 64 of drive clip arms 54 into inner surface 40 of bore 38 is further enhanced when bore 38 is formed by a drilling operation without subsequent finishing or fine machining of inner surface 40 of bore 38. In this manner, inner surface 40 of bore 38 is relatively roughened, and edges 64 of drive clip arms 54 may most easily engage and bite into inner surface 40. However, even when inner surface 40 of bore 38 is relatively smooth, edges 64 of drive clips arms 54 may still bite into inner surface 40 when drive clips 50a, 50b are made of a harder material than drive shaft 34. The driving engagement between drive clips 50a, 50b and drive shaft 34 prevents rotary motion between drive shaft 34 and drive clips 50a, 50b.

As shown in FIG. 4, drive clip arms 54 also conform to and engage the polygonal external surfaces 46 of end portion 44 of flexible cable 36 in an abutting manner, thereby preventing relative rotation between drive clips 50a or 50b and end portion 44 of flexible cable 36. In this manner, rotary motion from drive shaft 34 is transferred through drive clips 50a or 50b to end portion 44 of cable 36 as shown by the arrows in FIGS. 4 and 7, thereby drivingly coupling flexible cable 36 to drive shaft 34.

After assembly of drive system and subsequent operation of motor 32, the transfer of rotational torque between drive shaft 34 and end 44 of cable 36 through drive clips 50a, 50b may cause edges 64 of drive clip arms 54 to further bite into inner surface 40 of bore 38 of drive shaft 34 to thereby enhance the driving connection between drive clips 50a, 50b and drive shaft 34.

Advantageously, in drive system 30, because drive clips 50a or 50b engage inner surface 40 of bore 38 of drive shaft 34 to prevent relative rotation between drive clips 50a or 50b and drive shaft 34, the need for performing a broaching or other operation on drive shaft 34 in order to form a square or other polygonal shaped hole which conforms to or matches the shape of end portion 44 of flexible cable 36 is obviated, such that the difficulty of manufacturing drive assembly 30 is greatly reduced.

Although two drive clips 50b are shown in drive assembly 30, three or more drive clips 50b may also be used to drivingly couple drive shaft 34 to end portion 44 of flexible cable 36. For example, three drive clips, similar to drive clips 50b, may be inserted within bore 38 of drive shaft 34 in a stacked manner as described above, with the three drive clips having a total of six drive clip arms to match a hexagonally profiled end portion 44 of flexible cable 36. Further, the number of drive clip arms of a particular drive clip or drive clip combination need not match the number of polygonal surfaces 46 of the end portion 44 of the flexible cable 36. For example, a pair of drive clips 50b may include a total of four drive clip arms 54 engaging only four of the surfaces 46 of a hexagonally-shaped end portion 44 of a cable 36 to drivingly couple the cable 36 to the drive shaft 34 of a motor 18. Other variations will be apparent to one skilled in the art.

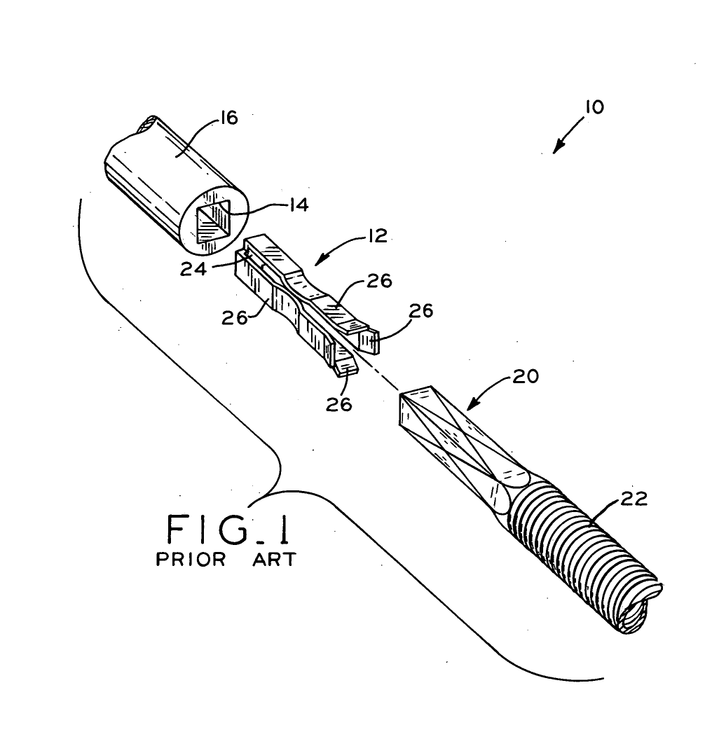

Drive clips 50a and 50b may also be used with known drive shafts including polygonal shaped holes, such as drive shaft 16 of motor 18, shown in FIG. 1, which includes broached hole 14. In these applications, the rotational, driving coupling between the drive shafts and the cable end portions is provided by the complimentary shapes thereof. Thus, drive clips 50a and 50b do not provide the driving connection in these applications between the drive shafts and the cable end portions, as in the above embodiments in which drive shafts 34 include a circular bore 38. Rather, in these applications, drive clips 50a and 50b function primarily to take up any spacing or gaps between the cable end portions and the polygonal shaped holes of the drive shafts.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A drive system, comprising:
a first rotatable component including a circular bore having an inner surface;
a second rotatable component having an end portion with at least one external surface, said end portion inserted within said bore; and
at least one drive clip disposed between said bore of said first component and said end portion of said second component, each said drive clip in driving engagement with said inner surface of said bore and in abutting engagement with said at least one external surface of said end portion, whereby rotary motion is transferred between said first and second components through said at least one drive clip.

2. The drive system of claim 1, wherein said end portion is polygonal shaped, including a plurality of end surfaces.

3. The drive system of claim 1, wherein said first component is a rotatably driven shaft, whereby rotary motion is transferred from said shaft to said second component through said at least one drive clip.

4. The drive system of claim 1, wherein said second component is a flexible cable, whereby rotary motion is transferred from said first component to said cable through said at least one drive clip.

5. The drive system of claim 1, wherein each said drive clip includes at least one arm portion having at least one edge in driving engagement with said inner surface of said bore.

6. The drive system of claim 5, wherein said driving engagement comprises a biting-in engagement of each edge of each arm portion into said inner surface of said bore.

7. The drive system of claim 5, wherein each arm portion of said drive clip includes an opposing pair of said edges each in driving engagement with said inner surface of said bore.

8. The drive system of claim 1, wherein a gap is defined between said inner surface of said bore and each drive clip.

9. The drive system of claim 1, including at least two of said drive clips, each drive clip including a pair of said arm portions extending from a base portion with respective pairs of said arm portions disposed parallel to one another.

10. The drive system of claim 1, including two of said drive clips within said bore, said drive clips oriented 90° with respect to one another.

11. The drive system of claim 1, wherein at least one of said external surfaces of said second component includes an upstand projecting therefrom, a portion of at least one said drive clip captured between said upstand and said inner surface of said bore.

12. A drive system, comprising:
a first rotatable component including a circular bore having an inner surface;
a second rotatable component having a polygonal shaped end portion with a plurality of external surfaces, said end portion inserted within said bore; and
at least one drive clip disposed between said bore of said first component and said end portion of said second component, each said drive clip comprising:
a pair of opposed arm portions in abutment with opposing external surfaces of said end portion of said second component, and
a pair of opposing edges on each arm portion, said edges in tight frictional driving engagement with said inner surface of said bore, whereby rotary motion is transferred between said first and second components through said at least one drive clip.

13. The drive system of claim 12, wherein said first component is a rotatably driven shaft, whereby rotary motion is transferred from said shaft to said second component through said at least one drive clip.

14. The drive system of claim 12, wherein said second component is a flexible cable, whereby rotary motion is transferred from said first component to said cable through said at least one drive clip.

15. The drive system of claim 12, wherein a gap is defined between said inner surface of said bore and each arm portion of each drive clip.

16. The drive system of claim 12, including two of said drive clips within said bore, said drive clips oriented 90° with respect to one another.

17. The drive system of claim 12, wherein at least one of said external surfaces of said second component includes an upstand projecting therefrom, a portion of said drive clip captured between said upstand and said inner surface of said bore.

18. A drive system, comprising:
a first rotatable component having a polygonal shaped hole therein;
a second rotatable component having a polygonal shaped end portion conforming in shape to said polygonal hole, said end portion inserted within said polygonal hole; and
at least two separate drive clips disposed between said polygonal hole and said end portion of said second component, each said drive clip including at least one arm portion in close fitting abutment between respective surfaces of said hole and said end portion, whereby rotary motion is transferred between said first and said second components through said drive clips.

19. The drive system of claim 18, including two of said drive clips within said polygonal hole, said drive clips oriented 90° with respect to one another.

20. The drive system of claim 18, wherein each said drive clip comprises a substantially U-shaped member including a base portion with a pair of said arm portions extending therefrom.

21. The drive system of claim 18, wherein said first component is a rotatably driven shaft, whereby rotary motion is transferred from said shaft to said second component through said at least one drive clip.

22. The drive system of claim 18, wherein said second component is a flexible cable, whereby rotary motion is transferred from said first component to said cable through said at least one drive clip.

23. A method of assembling a drive system, comprising the steps of:
inserting at least one drive clip having opposing arm portions with edges into a circular bore of a shaft;
inserting an end portion of a component into the bore between the drive clip arms; and
pressing the edges of the drive clip arms into tight frictional driving engagement with an inner surface of the bore.
